(19) United States
(12) Patent Application Publication
(10) Pub. No.: US 2014/0255858 A1
(43) Pub. Date: Sep. 11, 2014

(54) DEVICE TO PREHEAT A TAPE AND CONNECTED METHOD OF APPLICATION

(71) Applicant: I.M.A. INDUSTRIA MACCHINE AUTOMATICHE SPA, Ozzano dell'Emilia (IT)

(72) Inventor: Massimo Menzolini, Castel Bolognese (IT)

(73) Assignee: I.M.A. INDUSTRIA MACCHINE AUTOMATICHE SPA, Ozzano dell'Emilia (IT)

(21) Appl. No.: 14/350,124

(22) PCT Filed: Oct. 4, 2012
(86) PCT No.: PCT/IB2012/001976

§ 371 Date: Apr. 7, 2014

(30) Foreign Application Priority Data
Oct. 7, 2011 (IT) MI2011A001835

(51) Int. Cl. F27D 15/00

(52) U.S. Cl. CPC F27D 15/00
USPC 432/9; 432/227

(57) ABSTRACT

A device to preheat a tape for sealing containing compartments with a sealing tape, operates intervening by heating and tensioning a sealing tape by means of a panel.

### FIELD OF THE INVENTION

The present invention concerns the use of preheating means to preheat sealing tapes connected to containing elements to be sealed. The present invention also concerns the connected method.

### BACKGROUND OF THE INVENTION

It is known how, in the technique of producing blisters and other similar blister-type products, a sealing tape is applied continuously so as to isolate the compartments of the blisters, with their contents, from the outside environment. This technique is also used to seal different types of containing elements suitable both for solid and liquid substances; among these, for example, there are containers for medicines, food supplements such as vitamins and other medical substances and containers for food.

In this technique, a heated metal pressure roller heats the sealing tape before the latter enters into contrast with another roller, a drawing roller for example, of a tape where the blisters are. The sealing tape must be heated to a temperature such as to bring the tape and/or the layer of glue present on it, to the right temperature. Such temperature is that which guarantees a stable sealing following the subsequent pressure between the drawing or contrast roller and the pressure roller. It has been found that, up to a certain feed speed of the tape, the pressure roller is able to transmit the correct amount of heat energy to generate the desired effect.

One disadvantage concerns the relation between the increase in the feed speed of the tape and the surface temperature of the pressure roller. It has been found that, in order to use higher feed speeds aimed at increasing productivity, it is not possible to further raise the surface temperature of the pressure roller. This would cause problems both for the sealing tape and for the sealing itself.

From the patent application U.S. Pat. No. 4,310,365 a pressure roller with a rubber surface is known to which a heating panel is associated. The panel has the function of heating the surface portion of the rubber covering the roller, the insulating tape which covers the conductor plates and the conductor plates themselves. Furthermore, by heating the insulating tape, the panel enables the morphological adaption of the insulating tape to the corrugated surface of the layer to be insulated. In other words, the action of the panel does not allow the conductor plates to move laterally, thus maintaining a desired reciprocal geometric position. The reciprocal geometric position is essential for the correct behavior of the multi-channel tape. This system, due to its configuration, the way it works and its purposes, is not usable for the aims of the present invention.

It is also known to provide, in cooperation with the sealing roller, a heating panel which is positioned at the front of the sealing roller, but which is autonomous from the latter. This known technique, as well as creating downtimes for the maintenance operations, does not guarantee that the sealing tape stays perfectly in position.

The Applicant thus found himself in the position of having to study and create a device and method to obtain a secure and continuous seal even at high speeds of production adopted by sealing machines in general.

The Applicant has devised, tested and embodied the present invention to overcome the shortcomings of the state of the art and to obtain these and other purposes and advantages.

### SUMMARY OF THE INVENTION

The present invention is set forth and characterized in the independent claims, while the dependent claims describe other characteristics of the invention or variants to the main inventive idea.

In accordance with the above purpose, a device for preheating tapes according to the present invention consists of a heated metal pressure roller, or sealing roller, cooperating with a tape to be sealed and a sealing tape heated by the sealing roller and coming from a reel. From the union of the latter two elements the sealed product is obtained.

According to the present invention, a panel or plate, heated and/or heating, is directly associated to the sealing roller in order to heat the sealing tape. The panel is provided at the nearest point possible to the point or area of cooperation between the pressure roller and the contrast roller, very near to the sealing zone of the sealing tape by the sealing roller.

According to a first embodiment of the present invention, the reciprocal position between the heated and/or heating panel and the sealing roller remains fixed, whatever the angular position that the sealing roller assumes.

According to a first embodiment of the panel, this has a shape and a length such as to be able to be inserted as near as possible to the sealing zone.

According to one embodiment of the invention, the panel has a sliding surface for the sealing tape which acts as the heat exchange surface.

In one form of embodiment of the present invention, the sliding surface of the panel has means or elements with divarication or tensioning functions, in a direction transverse to the direction of feed of the sealing tape. The divarication means are disposed converging from one side and the other with respect to a center line of the sliding surface of the panel. These elements, keeping the sealing tape taut, serve to prevent the generation of irregular and uneven longitudinal behaviors in the sealing tape, which would cause imperfections in the sealing.

According to a further embodiment of the panel, this has heating elements inside it, which elements are, for example, electric resistances that can be inserted inside it.

According to a variant, which can be used together with the solution described above, channels of reduced sizes are made in the panel, to emit air which is introduced into the panel by means of at least an inlet pipe. The air can be heated to the desired temperature or the ambient temperature according to requirements. The channels end on the surface of the panel. The channels, on exit, can be flared so as to better distribute the pressure on the sealing tape and on the tape to be sealed and thus prevent undesired irregular profiles.

According to the invention, the panel must take the sealing tape to a temperature, which, later associated to the increase in temperature supplied by the heated metal pressure roller, ensures a complete and secure seal.

According to a variant, the panel transmits to the sealing tape the quantity of heat needed to reach the temperature of the pressure roller. In this case, the function of sealing rests mainly with the heated metal pressure roller.

The present invention also concerns a method of applying a sealing tape on containing compartments, in which a sealing is performed in a sealing zone between a heated metal roller, or sealing roller, and drawing and/or contrast means, for example a roller.

In accordance with the method of the present invention, near the sealing zone at least the sealing tape receives a heat contribution suitable to take it to the desired temperature, said contribution being obtained by means of a panel, said heat contribution being associated to a transverse divarication or tensioning action of the sealing tape.

### DESCRIPTION OF THE DRAWINGS

These and other characteristics of the present invention will become apparent from the following description of a preferential form of embodiment, given as a non-restrictive example with reference to the attached drawings wherein:

FIG. 1 is a view showing the normal application system of a sealing tape, in which the preheating device according to the present invention is applied, in an operating condition in which the metal heated pressure roller, or sealing roller, is adjacent to the contrast and/or drawing roller.

FIG. 2 is an example of FIG. 1 in a non-operating condition, in which the metal heated pressure roller, or sealing roller, is detached from the contrast and/or drawing roller;

FIG. 3 is an enlarged and sectioned detail of one form of embodiment of a panel of the device of the present invention;

FIGS. 3a, 3b, 3c, 3d, 3e, 3f show possible examples of flaring of the exit channels for the air of the panel in FIG. 3;

FIG. 4 shows the panel of the device of the present invention with one possible form of embodiment of the divarication elements;

FIG. 5 shows a three-dimensional view of the device of the present invention.

Functional parts that perform the same functions have the same reference numbers.

### DESCRIPTION OF SOME FORMS OF EMBODIMENT

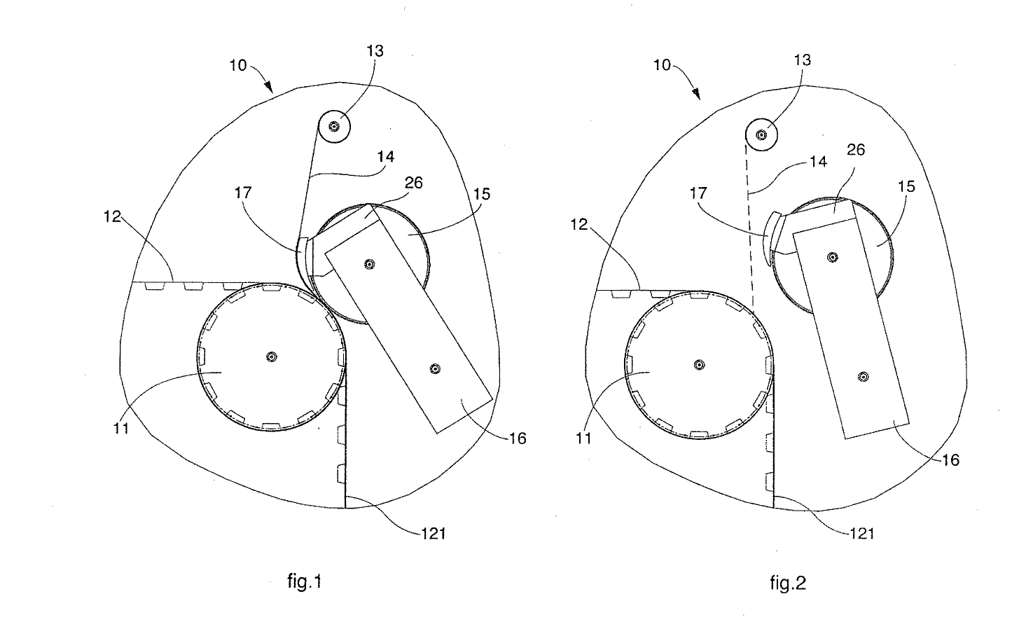

With reference to FIG. 1, a device 10 to preheat applied tape is shown, in this case applied for sealing tapes with blisters.

According to the invention, the device 10 works in cooperation with a tape 12 bearing the blisters. The device 10, in this case, consists of a heated and/or heating metal roller, or sealing roller, 15, which also has a pressure function, and a contrasting drawing roller 11 associated to the tape 12. The tape 12 to be sealed and the sealing tape 14, unwound from a reel 13, converge at the point, area or line of cooperation between said rollers 11 and 15. The point, area or line of cooperation corresponds to the sealing zone.

The sealing occurs as a result of the double action of pressure and heating exerted by the sealing roller 15, associated to the correct temperature of the sealing tape 14. In the part immediately before, that is upstream of, the sealing zone, with respect to the normal direction of feed of the sealing tape 14, a heated and/or heating panel or plate 17 is provided, able to increase the temperature of the sealing tape 14.

The sealing tape 14 is normally held in tension, in a known manner, while the sealing roller 15 is moved and positioned by a movement arm 16.

In particular, in FIG. 1, the device 10 is in an operating condition in which the sealing roller 15 is adjacent to the drawing roller 11, cooperating for the sealing.

With reference to FIG. 2, a possible non-operating condition of the system is shown, in which the sealing roller 15 is moved by the movement arm 16 with respect to the sealing position adjacent to the drawing roller 11 of FIG. 1.

It should be noted that, thanks to a support 26 associated to the movement arm 16, the reciprocal position of the panel 17 and the sealing roller 15 remains in any case constant, that is, fixed.

In this case, the support 26 is solid with one end of the movement arm 16. Therefore, in the example shown, the panel 17 is fixed to the support 26 and the sealing roller 15 is constrained to the movement arm 16.

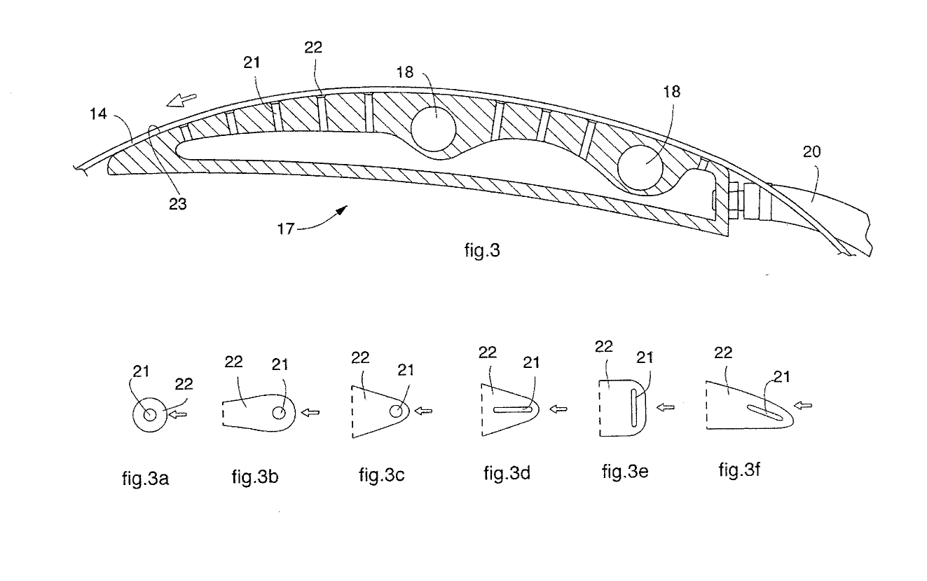

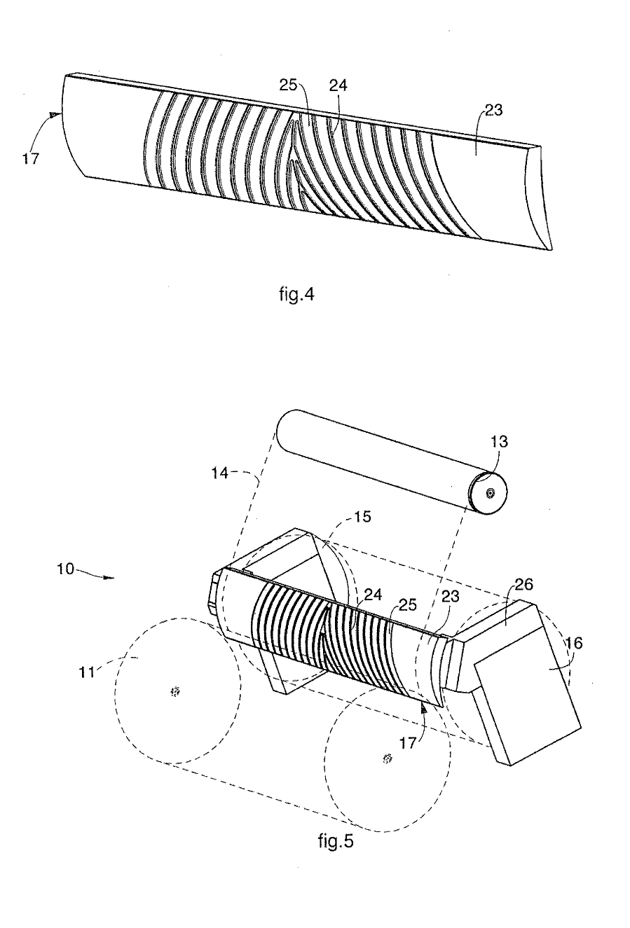

With reference to FIG. 3, the panel 17 is shown which, according to the present invention, has a sliding surface 23 for the sealing tape 14, which acts as a heat exchange surface.

The sliding surface 23 is provided, according to the present invention, with divarication or tensioning means or elements, 24 (FIG. 4).

With reference to FIG. 4, the panel 17 is shown comprising the cited divarication or tensioning means, or elements 24, provided on the sliding surface 23 and configured, in particular, to maintain the sealing tape 14 laterally taut.

In some forms of embodiment, the divarication elements 24 comprise at least two groups of divarication elements 24, which are disposed symmetrically on one side and the other with respect to a center line of the sliding surface 23.

Moreover, the divarication elements 24 are disposed inclined and converging toward the center line, in correspondence to which the ends of the divarication elements 24 are substantially adjacent (FIGS. 4 and 5). With reference to FIGS. 4 and 5, the divarication elements 24 are disposed for example converging upward. For example, the divarication elements 24 are configured in a herringbone pattern.

In particular the divarication elements 24 put the sealing tape 14 under tension in a direction transverse to its direction of feed, avoiding puckers and wrinkles due to the sudden increase in heat.

The divarication elements 24, advantageously configured as profiles in relief or protruding with respect to the sliding surface 23, can have, with respect to the axis of feed of the sealing tape 14, different angles depending on the characteristics of the sealing tape 14 and/or its feed speed. The divarication elements 24 can have flat support surfaces 25 (FIG. 5), or only shaped ridges. The divarication elements 24 can also have a constant or a variable development, for example, curvilinear, or cuspidal.

The provision of the divarication elements 24 allows to perform, in some forms of embodiment of the present invention, also at high speeds of feed of the tape 12 with blisters and of the sealing tape 14, and with a direction of feed tangent to the rollers 11 and 15, applying a sufficient tension to the sealing tape 14 in order to have lateral stability and an adequate contact pressure with the panel 17, and therefore an adequate transmission of heat, preventing, as indicated above, the formation of unwanted puckers or wrinkles.

The panel 17, in this specific case, also comprises heating elements 18 and outlet channels 21 of the air introduced therein by the inlet pipe 20. The outlet channels 21 reach the sliding surface 23 of the panel 17. The air can have the desired temperature. Moreover, the air can cooperate with the heating elements 18. If there is heated air, or a coexistence of heated air and the panel 17 heated by its own heating elements, the sealing roller 15 can also have a reduced surface temperature. The outlet channels 21, advantageously in the exit zone, have flarings 22 to improve the distribution of exiting air. The flarings 22 can also extend downstream of the respective outlet channels 21 and accompany the sealing tape 14. FIGS. 3a to 3f show possible example embodiments of flarings 22. In FIG. 3f, for example, the outlet channels 21 contribute to the divarication of the sealing tape 14 as above.

The panel 17 will advantageously be made of metal, but it can also be made of other material, ceramic for example, or comparable, or metal covered by ceramic material or similar, or vice versa.

FIG. 5 shows an example of embodiment of the device 10, which comprises two spaced movement arms 16, between which the sealing roller 15 (indicated for convenience with a broken line) is attached to corresponding supports 26. The drawing roller 11 (this, too, is shown for convenience with a broken line) is located in a coordinated position with respect to the sealing roller 15, so as to be able to act in cooperation with the latter on the sealing tape 14 (shown by a broken line in FIG. 5) fed from the reel 13 and on the tape 12, not shown here. The panel 17 of the present invention, in this case attached to the two supports 26, is disposed externally to the sealing roller 15, substantially between the latter and the drawing roller 11.

It is clear that modifications and/or additions of parts and/or steps may be made to the preheating device 10 and the corresponding method as described heretofore, without departing from the field and scope of the present invention.

It is also clear that, although the present invention has been described with reference to some specific examples, a person of skill in the art shall certainly be able to achieve many other equivalent forms of preheating device and corresponding method, having the characteristics as set forth in the claims and hence all coming within the field of protection defined thereby.

1.-15. (canceled)

16. A device for preheating a sealing tape for sealing containing compartments, comprising:
a sealing roller having a sealing zone,
a heating panel disposed near the sealing zone,
a sliding surface on the heating panel and the sliding surface having a center line, and
a divarication means on the sliding surface converging from one side and the other with respect to the center line, acting in a direction transverse to the feeding direction of the sealing tape and having profiles in relief that protrude with respect to the sliding surface.

17. The device of claim 16, wherein the divarication means is configured in a herringbone pattern.

18. The device of claim 16, wherein the divarication means has a flat support surface.

19. The device of claim 16, wherein the divarication means has a cusp-type development.

20. The device of claim 16, wherein the divarication means further comprises at least two groups of divarication elements disposed symmetrically from one side and the other with respect to the center line of the sliding surface.

21. The device of claim 20, wherein the divarication elements are configured converging upward.

22. The device of claim 16 further comprising a movement arm configured to move and position the sealing roller.

23. The device of claim 16, wherein the heating panel and the sealing roller have a fixed reciprocal position.

24. The device of claim 22 further comprising a support coupled with the movement arm and the heating panel.

25. The device of claim 24, wherein the support is fixed to one end of the movement arm.

26. The device of claim 24, wherein the heating panel is fixed to the support and the sealing roller is connected to the movement arm.

27. The device of claim 16 further comprising at least one heating element inside the heating panel.

28. The device of claim 16, wherein the heating panel further comprises at least one air inlet pipe and at least one outlet channel and both cooperate with the surface of the sealing tape.

29. The device of claim 28, wherein the outlet channel has a flared means.

30. The device of claim 16, wherein the heating panel is made of a heat transmitting material.

31. The device of claim 16, wherein the heating panel is made of a metal material.

32. The device of claim 16, wherein the heating panel is substantially made of ceramic material.

33. A heating panel for a device for preheating a sealing tape in a sealing device comprising,
a sliding surface having a center line and
a divarication means on the sliding surface, converging from one side and the other with respect to the center line of the sliding surface, acting in a direction transverse to the feeding direction of a sealing tape and having profiles in relief that protrude with respect to the sliding surface.

34. A method for applying a sealing tape on containing compartments by a sealing roller comprising the steps of:
heating a heating panel to a desired temperature,
providing heat from the heating panel to a sealing tape, and
associating the heat with an action of transverse divarication of the sealing tape.

35. The method of claim 34 further comprising:
positioning a sealing roller so that it automatically moves the heating panel.
